(19) United States
(12) Patent Application Publication
(10) Pub. No.: US 2026/0186316 A1
(43) Pub. Date: Jul. 2, 2026

(54) STEREOSCOPIC IMAGE DISPLAY DEVICE AND OPTICAL SHEET

(71) Applicant: FUJIFILM Corporation, Tokyo (JP)

(72) Inventor: Makoto KAMO, Minamiashigara-shi (JP)

(73) Assignee: FUJIFILM Corporation, Tokyo (JP)

(21) Appl. No.: 19/547,720

(22) Filed: Feb. 24, 2026

Related U.S. Application Data
(63) Continuation of application No. PCT/JP2024/032905, filed on Sep. 13, 2024.

(30) Foreign Application Priority Data
Sep. 26, 2023 (JP) 2023-162428

(51) Int. Cl. G02B 30/10; G02B 5/00; G02B 5/30; G02B 30/27

(52) U.S. Cl. CPC G02B 30/10; G02B 5/003; G02B 5/3016; G02B 5/3033; G02B 30/27; G02B 2207/101

(57) ABSTRACT

Provided are a stereoscopic image display device having high display contrast, and an optical sheet with which high display contrast can be obtained for use in a stereoscopic image display device. The stereoscopic image display device includes, in the following order a lens array, a directivity control layer, and a light-emitting image display element, in which one surface of the lens array has a planar shape, and another surface of the lens array has a curved shape, the directivity control layer is disposed on the planar surface side of the lens array, in a case where the directivity control layer is irradiated with light from one surface side, the directivity control layer has a highest luminance in a normal direction of another surface of the directivity control layer. Accordingly, the object is achieved.

### CROSS-REFERENCE TO RELATED APPLICATIONS

This application is a Continuation of PCT International Application No. PCT/JP2024/032905 filed on September 13, 2024, which claims priority under 35 U.S.C. § 119(a) to Japanese Patent Application No. 2023-162428 filed on September 26, 2023. The above applications are hereby expressly incorporated by reference, in their entirety, into the present application.

### BACKGROUND OF THE INVENTION

### 1. Field of the Invention

The present invention relates to a stereoscopic image display device and an optical sheet used for the stereoscopic image display device.

### 2. Description of the Related Art

A stereoscopic image display device where a lens array such as a lenticular lens or a microlens array is combined with an image display element such as a liquid crystal display to display a stereoscopic image is known.

For example, JP2012-93631A describes a stereoscopic image display device (three-dimensional image display device) including:

a display device unit that can simultaneously display a plurality of videos having parallax, includes, as one set, a plurality of display pixels displaying the plurality of videos having parallax, respectively, and includes a display panel where plural sets of the display pixels are disposed in a matrix;

a lenticular lens that is provided on an emission side of video light of the display panel, includes a plurality of unit lenses having a partial shape of a substantially circular cylindrical shape or a partial shape of a substantially elliptic cylindrical shape and arranged on a surface of the emission side, and emits each of the video light components of the plurality of videos having parallax in a predetermined direction; and

a light control sheet that is disposed between the lenticular lens and the display panel and includes a light-transmitting unit and a light-absorbing unit alternately arranged along an arrangement direction of the unit lenses.

### SUMMARY OF THE INVENTION

The stereoscopic image display device including the lens array divides a plurality of images corresponding to parallax of left and right eyes according to the lens array, and arranges and displays the divided images. In a case where an observer observes the images through the lens array, images are reconstructed at positions of the left and right eyes of the observer and observed as a stereoscopic image.

That is, according to the stereoscopic image display device including the lens array and the image display element, the observer can observe the stereoscopic image with the naked eyes without using special glasses such as glasses including a polarizer.

However, in the stereoscopic image display device in the related art that can observe the stereoscopic image with the naked eyes, display contrast is not sufficient, and improvement is required.

An object of the present invention is to solve the above-described problem of the related art and to provide a stereoscopic image display device having high display contrast, and an optical sheet that can improve display contrast for use in a stereoscopic image display device.

In order to achieve such objects, the present invention has the following configurations.

[1] A stereoscopic image display device comprising, in the following order:

a lens array where a plurality of lenses are disposed in a planar shape;

a directivity control layer; and

a light-emitting image display element,

in which one surface of the lens array has a planar shape, and another surface of the lens array has a curved shape,

the directivity control layer is disposed on the planar surface side of the lens array,

the directivity control layer is selected from the group consisting of an anisotropic absorption layer including a dichroic substance, a diffraction element, a metasurface structure, and a laminate including a polarizer, a retardation layer, and a polarizer, and

in a case where the directivity control layer is irradiated with light from one surface side, the directivity control layer has a highest luminance in a normal direction of another surface of the directivity control layer.

[2] The stereoscopic image display device according to [1],

in which the directivity control layer is the anisotropic absorption layer including the dichroic substance, and a transmittance central axis is parallel to a normal direction of the planar surface of the lens array.

[3] The stereoscopic image display device according to [2],

in which the anisotropic absorption layer includes a vertically aligned liquid crystal compound.

[4] The stereoscopic image display device according to any one of [1] to [3],

in which the lens array is a lenticular lens.

[5] The stereoscopic image display device according to [4], further comprising:

a polarizer that is provided between the image display element and the directivity control layer,

in which a transmission axis of the polarizer is a direction perpendicular to a longitudinal direction of a lens forming the lenticular lens.

[6] The stereoscopic image display device according to any one of [1] to [3],

in which the lens array is a microlens array.

[7] An optical sheet comprising:

a lens array where a plurality of lenses are disposed in a planar shape; and

an anisotropic absorption layer including a dichroic substance,

in which one surface of the lens array has a planar shape, and another surface of the lens array has a curved shape,

the anisotropic absorption layer is disposed on the planar surface side of the lens array, and

a transmittance central axis of the anisotropic absorption layer is parallel to a normal direction of the planar surface of the lens array.

[8] The optical sheet according to [7],

in which the anisotropic absorption layer includes a vertically aligned liquid crystal compound.

[9] The optical sheet according to [7] or [8],

in which the lens array is a lenticular lens.

[10] The optical sheet according to [9], further comprising:

a polarizer that is provided opposite to the lens array side of the anisotropic absorption layer,

in which a transmission axis of the polarizer is a direction perpendicular to a longitudinal direction of a lens forming the lenticular lens.

[11] The optical sheet according to [7] or [8],

in which the lens array is a microlens array.

According to the present invention, it is possible to provide a stereoscopic image display device having high display contrast, and an optical sheet that can improve display contrast for use in a stereoscopic image display device.

### BRIEF DESCRIPTION OF THE DRAWINGS

FIG. 1 is a diagram conceptually showing an example of a stereoscopic image display device according to the present invention.

FIG. 2 is a diagram conceptually showing an example of emission characteristics of a light emitting element of an image display element.

FIG. 3 is a graph showing an example of the emission characteristics of the light emitting element of the image display element.

FIG. 4 is a graph showing a simulation result of absorption characteristics of an anisotropic absorption layer.

FIG. 5 is a graph showing a simulation result of a light amount distribution of light transmitted through the anisotropic absorption layer.

FIG. 6 is a diagram conceptually showing another example of the stereoscopic image display device according to the present invention.

FIG. 7 is a graph showing a simulation result of a light transmittance in a laminate including the anisotropic absorption layer and a polarizer.

FIG. 8 is a graph showing a simulation result of a light amount distribution of light transmitted through the laminate including the anisotropic absorption layer and the polarizer.

### DESCRIPTION OF THE PREFERRED EMBODIMENTS

Hereinafter, a stereoscopic image display device and an optical sheet according to the present invention will be described in detail.

The following description may be realized based on a representative embodiment of the present invention. On the other hand, the present invention is not limited to this embodiment.

In the present specification, a numerical range expressed using “to” refers to a range including numerical values described before and after “to” as a lower limit value and an upper limit value.

Further, all the drawings described below are conceptual views for describing the present invention. Accordingly, a shape, a size, and a thickness of each of members, a positional relationship such as a disposition position or an interval of each of layers, and the like do not necessarily match with the actual ones.

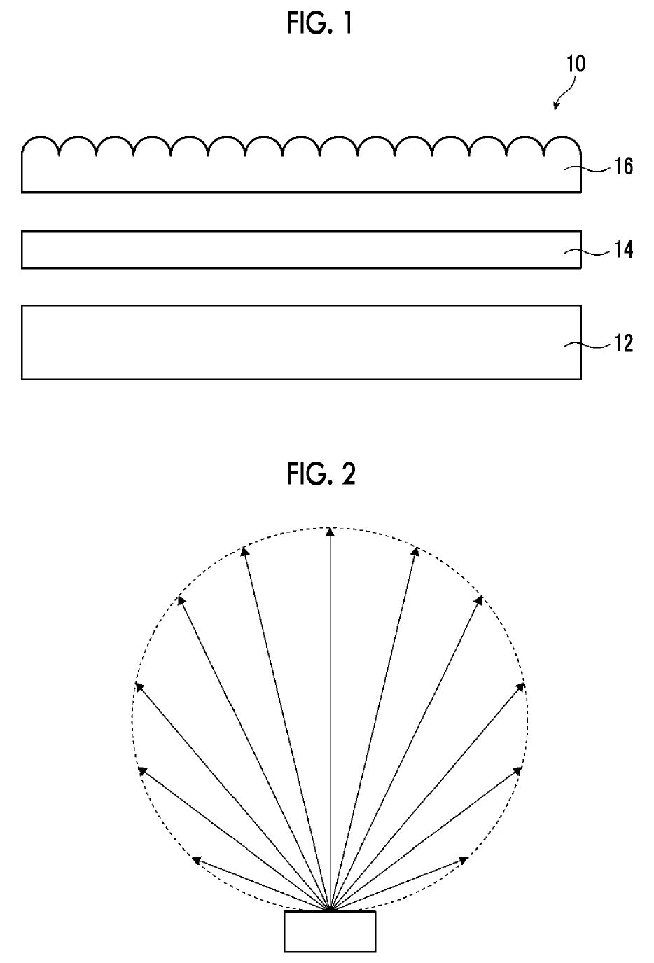

FIG. 1 is a diagram conceptually showing an example of a stereoscopic image display device according to an embodiment of the present invention.

A stereoscopic image display device 10 shown in FIG. 1 includes an image display element 12, an anisotropic absorption layer 14, and a microlens array 16 in this order. The anisotropic absorption layer 14 is the directivity control layer according to the embodiment of the present invention. In addition, the microlens array 16 is the lens array according to the embodiment of the present invention.

In the lens array of the stereoscopic image display device according to the embodiment of the present invention, a plurality of lenses are disposed (arranged) in a planar shape, one surface has a flat shape, and another surface has a curved shape. In the present invention, the plane is not limited to a complete plane, and also includes a substantial plane including inevitable unevenness.

In the present invention, one surface of the lens array having a curved shape represents that this surface does not include a vertex where two straight lines intersect each other and a ridge where two planes intersect each other. Specifically, the lens forming the lens array is a lens that does not include a vertex unlike an axicon lens and does not include a ridge unlike a prism.

In addition, the anisotropic absorption layer 14 includes a dichroic substance, and a transmittance central axis is parallel to a normal direction of the planar surface of the microlens array 16 (lens array).

The normal direction refers to a direction perpendicular to a main surface of a sheet-like material (a layer, a film, or a plate-like material). In addition, the normal line is a line perpendicular to the surface of the sheet-like material.

That is, a combination of the anisotropic absorption layer 14 and the microlens array 16 (lens array) composes the optical sheet according to the embodiment of the present invention. Accordingly, the stereoscopic image display device 10 shown in FIG. 1 is the stereoscopic image display device according to the embodiment of the present invention including the optical sheet according to the embodiment of the present invention.

Here, in the stereoscopic image display device according to the embodiment of the present invention, as the directivity control layer, in addition to the anisotropic absorption layer 14 in the example shown in the drawing, a diffraction element, a metasurface structure, and a laminate including a polarizer, a retardation layer, and a polarizer can also be used. This point will be described in detail below.

In the stereoscopic image display device 10 according to the embodiment of the present invention, the image display element 12 is the light-emitting image display element.

In a case where the image display element 12 is a light-emitting image display element, a known image display element (image display device, display) can be used. Preferable examples of the image display element include a light emitting diode (LED) display element, a micro LED display element, and an organic electro luminescence (EL) display element (organic light emitting diode (OLED)).

In the stereoscopic image display device 10 according to the embodiment of the present invention, the image display element 12 is a general light-emitting image display element.

As in a known image display element of a stereoscopic image display device capable of naked-eye observation using a lens array, the image display element 12 in the stereoscopic image display device 10 divides a plurality of images corresponding to the viewpoint of an observer according to the microlens array 16, and arranges and displays the divided images.

Regarding this point, the same applies to a case where the stereoscopic image display device according to the embodiment of the present invention includes another lens array such as a lenticular lens.

In the stereoscopic image display device 10 according to the embodiment of the present invention, as the microlens array 16, various known microlens arrays used in a stereoscopic image display device that displays a stereoscopic image with the naked eye using a lens array can be used as long as one surface has a planar shape and another surface has a curved shape.

In the stereoscopic image display device according to the embodiment of the present invention, the lens array is not limited to the microlens array 16. That is, in the stereoscopic image display device according to the embodiment of the present invention, various known lens arrays used in a stereoscopic image display device capable of naked-eye observation can be used as long as the lens array is an array where a plurality of lenses are arranged in a planar shape, as long as one surface has a planar shape and another surface has a curved shape as described above.

As the lens array, in addition to the microlens array 16 in the example shown in the drawing, for example, a structure such as a lenticular lens or a fly‐eye lens where a convex structure is disposed on a spherical cap or semi-cylindrical shape can be used.

Here, in the stereoscopic image display device 10 according to the embodiment of the present invention, the microlens array 16, that is, the lens array is disposed such that the planar surface faces toward the anisotropic absorption layer 14, that is, the directivity control layer. That is, the microlens array 16 is disposed such that the planar surface faces the image display element 12.

In other words, the anisotropic absorption layer 14 is provided on the planar surface side of the microlens array 16.

The stereoscopic image display device according to the embodiment of the present invention includes the lens array, the directivity control layer, and the image display element in this order.

Accordingly, in the stereoscopic image display device 10 according to the embodiment of the present invention, the anisotropic absorption layer 14 is provided between the image display element 12 and the microlens array 16.

That is, in the stereoscopic image display device 10, the image displayed by the image display element 12 transmits through the anisotropic absorption layer 14, is incident into the microlens array 16, is refracted by the microlens array 16, and is observed by an observer as a stereoscopic image.

Here, the anisotropic absorption layer 14 is the directivity control layer according to the embodiment of the present invention, includes a dichroic substance, and is a layer where a transmittance central axis is parallel to a normal direction of the planar surface of the microlens array 16 (lens array).

In the present invention, the meaning of “being parallel to the normal direction of the planar surface of the microlens array 16” includes not only being completely parallel to the normal direction of the planar surface but also an angle range of ±5° with respect to the normal direction of the planar surface. Regarding this point, the same applies to an expression such as being parallel to a normal direction of the directivity control layer or main surfaces of a member being parallel to each other.

In the present invention, in a case where the directivity control layer is irradiated with light from one surface side, the directivity control layer has the highest luminance in a normal direction of another surface of the directivity control layer. Specifically, the directivity control layer changes a polar angle and an azimuthal angle in various ways such that, in a case where the layer is irradiated with light from the one surface side in various directions, a luminance of light transmitted through and emitted from the other surface of the layer is the highest in the normal direction. In the present invention, the meaning of the normal direction includes not only a direction that completely matches with a normal line of a main surface, that is, a direction completely perpendicular to (line perpendicular to) the main surface but also an angle range of ±5° with respect to the normal line of the planar surface, as described above.

That is, light incident from the normal direction of the main surface transmits through the directivity control layer, and light incident with an angle with respect to the normal direction of the main surface is absorbed by the directivity control layer, or is changed in optical path to be emitted as light parallel to the normal direction of the main surface.

The main surface is a maximum surface of a sheet-like material (a film, a layer, a plate-like material, or a layer), and is usually on both surfaces of the sheet-like material in a thickness direction.

Here, the anisotropic absorption layer 14 is the directivity control layer, includes a dichroic substance, and is a layer where a transmittance central axis is parallel to the normal direction of the planar surface of the microlens array 16.

In the present invention, the transmittance central axis is a direction in which the transmittance is the highest in a case where the transmittance of the surface of the layer is measured in various direction while changing a polar angle and an azimuthal angle in various ways.

In the anisotropic absorption layer 14 that is a layer where a transmittance central axis is parallel to the normal direction of the planar surface of the microlens array 16, light incident from the normal direction of the planar surface of the microlens array 16 transmits through the anisotropic absorption layer 14, and light incident in a direction that is tilted with respect to the normal line, that is, that is oblique to the normal line is absorbed by the anisotropic absorption layer 14.

In the stereoscopic image display device 10 according to the embodiment of the present invention, typically, the main surface of the anisotropic absorption layer 14 is disposed parallel to the planar surface of the microlens array 16. Accordingly, in the stereoscopic image display device 10, the normal direction of the planar surface of the microlens array 16 matches with the normal direction of the main surface of the anisotropic absorption layer 14.

In the following description, the normal direction of the planar surface of the microlens array 16 and the normal direction of the main surface of the anisotropic absorption layer 14 will also be simply referred to as “normal direction”.

That is, in the stereoscopic image display device 10, light of an image displayed by the light-emitting image display element 12 is light that is allowed to travel in the normal direction (substantially in the normal direction) by the anisotropic absorption layer 14, and the light traveling in the normal direction is incident into the microlens array 16 to display a stereoscopic image.

In the stereoscopic image display device 10 according to the embodiment of the present invention that includes the microlens array 16 (lens array) and can view a stereoscopic image with the naked eyes, the anisotropic absorption layer 14 (directivity control layer) is provided between the microlens array 16 and the image display element 12 to improve the display contrast of a stereoscopic image.

The stereoscopic image display device 10 in the example shown in the drawing includes the microlens array 16, and is a type called a light field display.

In the stereoscopic image display device, using the lens array such as the microlens array that is provided between the image display element and the observer, an image on the image display element is re-disposed depending on the observation angle, and a set of images from the respective lenses of the microlens array reconstructs the original image at an observation point.

In a case where the images on the image display element are disposed such that the images reconstructed at the positions of the left and right eyes of the observer reproduce the parallax of the left and right eyes to the observer, the observer can feel stereoscopic image display with the naked eyes.

Regarding this point, the same also applies to a stereoscopic image display device including a lens array such as a lenticular lens.

As described above, as the microlens array 16, known arrays used for stereoscopic image display can be used. Accordingly, as a shape of the microlens array (lens array), various shapes can be adopted depending on a resolution and a pixel structure of the image display element to be used, and the quality of an image to be displayed.

Here, in order to simplify the description, a microlens array where plano‐convex lenses having a simple spherical surface are arranged will be described as an example. However, the gist of the present invention is not necessarily limited to these examples. For example, plano‐concave lenses may be arranged instead of the shape of the plano‐convex lenses. In addition, the lenses may have an aspherical surface instead of the spherical surface.

In a case where the plano‐convex lenses are used and a plane side faces the image display element side, it is preferable that a ray incident from the image display element side into the lens is parallel to an optical axis of the lens.

However, regarding individual pixels forming the actual image display element, in particular, regarding individual pixels forming the light-emitting display device that is advantageous from the viewpoint of power consumption, it is known that a light amount distribution thereof has angle spread to some extent even in a case where an ideal point light source is assumed. Each of the pixels forming the image display element is, for example, one light emitting point (point light source).

Therefore, in the light amount distribution of light emitted from the point light source, light emitted at an emission angle that deviates to some extent from the light emitting point is stray light that does not form an image on the pupil of the observer such that the contrast of the display image decreases. That is, this stray light is emitted from the lens forming the lens array as light having no relationship with the image, and is recognized as background light that is distributed in the entire visual field of the observer. Therefore, as the light amount increases, the display contrast decreases.

In the stereoscopic image display device according to the embodiment of the present invention, by providing the directivity control layer between the image display element and the lens array, the stray light component can be reduced. As described above, in the stereoscopic image display device 10 in the example shown in the drawing, by providing the anisotropic absorption layer 14 as the directivity control layer between the image display element 12 and the microlens array 16, the stray light component can be reduced.

The stereoscopic image display device according to the embodiment of the present invention includes, as the directivity control layer, one or more selected from the group consisting of the anisotropic absorption layer 14, a diffraction element, a metasurface structure, and a laminate including a polarizer, a retardation layer, and a polarizer. That is, the stereoscopic image display device according to the embodiment of the present invention includes, as the directivity control layer, a directivity control layer that includes a hyperfine structure or diffractive optical path control element and uses reflection or absorption of angle selectivity on a plate. As a result, accurate alignment of the directivity control layer and the light emitting element (pixel) of the image display element is unnecessary, the desired stray light removal effect is exhibited, and the contrast can be improved.

In particular, a stereoscopic image having a natural stereoscopic effect can be displayed. Therefore, in a case where an image display element having a high definition of higher than 100 ppi is used, a deviation in alignment affects the display contrast. Therefore, it is necessary to use the above-described directivity control layer.

In order to allow the stereoscopic image display device to display a stereoscopic image having a natural stereoscopic effect, angular separability that is about half of a distance between the pupils of a person is necessary. The distance between the pupils of a person is about 5 cm on average.

Accordingly, in a case where use in a distance range of about 1 m from the stereoscopic image display device is assumed, one pixel (light emitting point) on the image display element may be re-disposed in an angle range of about 1.5°.

For example, in a case where a microlens array where a plurality of lenses that are formed of a material having a refractive index of 1.6 and have a curvature radius of 1 mm and a lens outer diameter of 0.8 mm are arranged is used in order to realize this arrangement, an interval between light components emitted from adjacent pixels (light emitting points) is calculated as about 0.02 mm.

In a case where it is assumed that the light emitting element forming each of the pixels is the point light source, light emitted at an angle exceeding the angle range enters into a range of the light components that are emitted from the adjacent pixels and are focused as images at the pupils of the observer, that is, is converted into the above-described stray light that decreases the display contrast. Therefore, it is preferable that a cone where the above-described interval (0.02 mm) is a diameter of a bottom surface and a distance from the light emitting element to the lens is a height is set to remove light outside the cone.

In addition, assuming that a distance from the light emitting element to a surface formed along the lens outer diameter is 0.4 mm, it is preferable to remove light present outside a range of ±2.5° with respect to a direction parallel to the optical axis of the lens. In other words, the surface formed along the lens outer diameter is the planar surface of the microlens array.

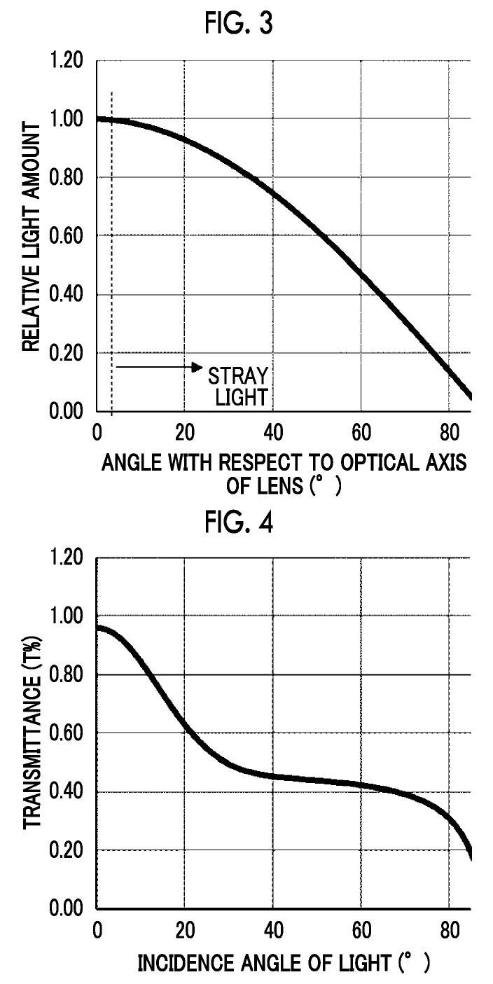

For example, the micro LED display element is assumed as the image display element, and as shown in FIGS. 2 and 3, a uniform diffusion type light amount distribution from the point light source is assumed as the light amount distribution from a bare chip of the light emitting element.

In this case, 90% or more of light emitted from the light emitting element is converted into stray light such that the display contrast decreases.

On the other hand, a case where an anisotropic absorption layer that includes a dichroic coloring agent and where a transmittance central axis is parallel to the normal direction, that is, the normal direction of the planar surface of the lens array (the normal direction of the layer main surface) as described above is simulated.

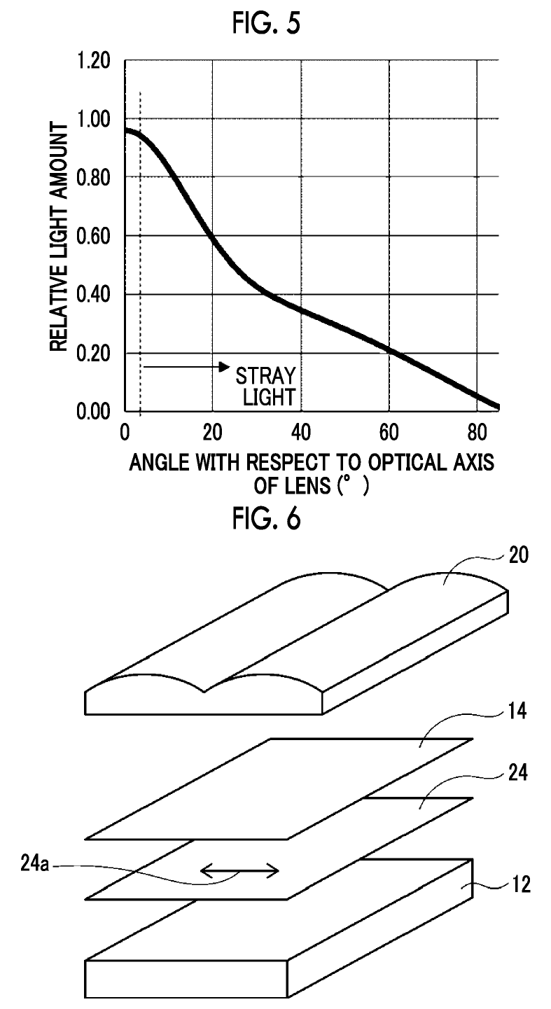

For example, in any cross section of the anisotropic absorption layer, a transmittance of the anisotropic absorption layer with respect to an incidence angle of light is as shown in FIG. 4. In a case where the anisotropic absorption layer is disposed on an emission surface of the image display element on the image display surface side (light emission side), the light amount distribution of the light emitted from the light emitting element having the light amount distribution shown in FIGS. 2 and 3 is changed as shown in FIG. 5.

As a result, the light amount of the stray light can be reduced to about 60% with respect to the light emitted from the bare chip.

That is, in the stereoscopic image display device 10 according to the embodiment of the present invention, in the light emitted from each of the pixels (light emitting element/light emitting point) of the light-emitting image display element 12, light that enters into the range of adjacent pixels as stray light can be absorbed by the anisotropic absorption layer 14, and light that forms an image at the pupil of the observer and travels in the normal direction can be selectively incident into the microlens array 16.

As a result, the stereoscopic image display device 10 according to the embodiment of the present invention suppresses a decrease in display contrast caused by stray light, and can display a stereoscopic image having high display contrast.

In the stereoscopic image display device 10 according to the embodiment of the present invention, the anisotropic absorption layer 14 includes a dichroic substance, and the transmittance central axis is parallel to the normal direction.

As described above, the main surface of the anisotropic absorption layer 14 is parallel to the planar surface of the microlens array 16. Accordingly, examples of the anisotropic absorption layer 14 include a layer where the dichroic substance is vertically aligned with respect to the main surface of the layer.

In the present invention, the dichroic substance refers to a coloring agent having different absorbances depending on directions. The dichroic substance may or may not exhibit liquid crystallinity.

The dichroic substance is not particularly limited, and examples thereof include a visible light absorbing material (dichroic coloring agent), a light emitting material (a fluorescent material or a phosphorescent material), an ultraviolet absorbing material, an infrared absorbing material, a nonlinear optical material, carbon nanotube (CNT), and an inorganic material (for example, a quantum rod). Further, a known dichroic substance (dichroic colorant) in the related art can be used.

Specific examples thereof include those described in paragraphs [0067] to [0071] of JP2013-228706A, paragraphs [0008] to [0026] of JP2013-227532A, paragraphs [0008] to [0015] of JP2013-209367A, paragraphs [0045] to [0058] of JP2013-14883A, paragraphs [0012] to [0029] of JP2013-109090A, paragraphs [0009] to [0017] of JP2013-101328A, paragraphs [0051] to [0065] of JP2013-37353A, paragraphs [0049] to [0073] of JP2012-63387A, paragraphs [0016] to [0018] of JP1999-305036A (JP-H11-305036A), paragraphs [0009] to [0011] of JP2001-133630A, [0030] to [0169] of JP2011-215337A, paragraphs [0021] to [0075] of JP2010-106242A, paragraphs [0011] to [0025] of JP2010-215846A, paragraphs [0017] to [0069] of JP2011-048311A, paragraphs [0013] to [0133] of JP2011-213610A, paragraphs [0074] to [0246] of JP2011-237513A, paragraphs [0005] to [0051] of JP2016-006502A, paragraphs [0014] to [0032] of JP2018-053167A, paragraphs [0014] to [0033] of JP2020-11716A, paragraphs [0005] to [0041] of WO2016/060173A, paragraphs [0008] to [0062] of WO2016/136561A, paragraphs [0014] to [0033] of WO2017/154835A, paragraphs [0014] to [0033] of WO2017/154695A, paragraphs [0013] to [0037] of WO2017/195833A, paragraphs [0014] to [0034] of WO2018/164252A, paragraphs [0021] to [0030] of WO2018/186503A, paragraphs [0043] to [0063] of WO2019/189345A, paragraphs [0043] to [0085] of WO2019/225468A, paragraphs [0050] to [0074] of WO2020/004106A, and paragraphs [0015] to [0038] of WO2021/044843A.

In the present invention, two or more dichroic substances may be used in combination.

For example, from the viewpoint of making the anisotropic absorption layer 14 closer to black, at least one kind of dichroic substance having a maximum absorption wavelength in a wavelength range of 370 to 550 nm and at least one kind of dichroic substance having a maximum absorption wavelength in a wavelength range of 500 to 700 nm are preferably used in combination.

A method of forming the anisotropic absorption layer 14 is not particularly limited, and various known forming methods in which the dichroic substance can be vertically aligned with respect to the main surface of the layer can be used.

For example, from the viewpoint of aligning the dichroic substance with a high alignment degree, a method of forming the anisotropic absorption layer 14 using a liquid crystal composition including a liquid crystal compound together with the above-described dichroic substance can be suitably used.

In the present invention, the liquid crystal compound is a liquid crystal compound that is not dichroic.

As the liquid crystal compound, both a low-molecular-weight liquid crystal compound and a polymer liquid crystal compound can be used, and from the viewpoint of increasing the alignment degree, a polymer liquid crystal compound is preferable. Here, “low-molecular-weight liquid crystal compound” refers to a liquid crystal compound not including a repeating unit in a chemical structure. In addition, “polymer liquid crystal compound” refers to a liquid crystal compound including a repeating unit in a chemical structure.

Examples of the low-molecular-weight liquid crystal compound include a liquid crystal compound described in JP2013-228706A.

Examples of the polymer liquid crystal compound include thermotropic liquid crystal polymers described in JP2011-237513A. Further, the polymer liquid crystal compound may include a crosslinkable group (such as an acryloyl group or a methacryloyl group) at a terminal.

The liquid crystal compound may be used alone or in combination of two or more kinds thereof.

From the viewpoint of further improving the alignment degree of the anisotropic absorption layer 14, it is preferable that the liquid crystal compound includes a polymer liquid crystal compound.

In addition, the liquid crystal composition may include a solvent, a polymerization initiator, an interface modifier, and other components.

The anisotropic absorption layer 14 may be formed using a known method.

For example, during the formation of the anisotropic absorption layer 14 using the liquid crystal composition, the liquid crystal composition is applied to an alignment film to which aligning properties of the liquid crystal compound are imparted. Next, the liquid crystal composition is heated and/or cooled or is repeatedly heated and cooled, the liquid crystal compound is aligned in a thickness direction. Due to the alignment of the liquid crystal compound, the dichroic substance is also aligned in the thickness direction.

Next, optionally, by irradiating the liquid crystal composition with ultraviolet rays to cure the liquid crystal composition, the anisotropic absorption layer 14 where the dichroic substance is aligned in the thickness direction can be formed.

As described above, in the stereoscopic image display device according to the embodiment of the present invention, a lenticular lens can also be suitably used as the lens array.

As described above, as the lenticular lens, various known lenticular lenses used for stereoscopic image display with naked eyes can be used.

Here, as conceptually shown in FIG. 6, in a case where a lenticular lens 20 is used as the lens array, it is preferable that a polarizer 24 is provided between the image display element 12 and the anisotropic absorption layer 14. In FIG. 6, in order to simplify the drawing for easy understanding of the configuration of the present invention, only two lenses are shown as lenses forming the lenticular lens 20. However, it is known that, in the lenticular lens, many elongated lenses are arranged in a direction perpendicular to a longitudinal direction.

In this case, the polarizer 24 disposes a transmission axis 24a in the direction perpendicular to the longitudinal direction of the lenses (cylindrical lenses) forming the lenticular lens. That is, the polarizer 24 shields linearly polarized light in the longitudinal direction of the lenses forming the lenticular lens.

As described above, the anisotropic absorption layer 14 includes the dichroic substance and has the transmittance central axis in the normal direction. That is, in the anisotropic absorption layer 14, the dichroic substance is vertically aligned with respect to the main surface.

The anisotropic absorption layer 14 allows transmission of light incident in the normal direction, and absorbs light incident from the direction that is tilted with respect to the normal line, that is, that is oblique to the normal line.

Here, in the light incident from the oblique direction, the anisotropic absorption layer 14 can suitably absorb linearly polarized light in the normal direction with respect to the main surface. The linearly polarized light in the direction perpendicular to the normal line has low absorbance. In other words, in the light incident from the oblique direction, the anisotropic absorption layer 14 can suitably absorb linearly polarized light in the alignment direction of the dichroic substance. The linearly polarized light in the direction perpendicular to the alignment direction of the dichroic substance has low absorbance.

That is, in the light incident from the oblique direction, the anisotropic absorption layer 14 can suitably absorb the linearly polarized light in the direction perpendicular to the longitudinal direction of the lenses forming the lenticular lens. The linearly polarized light in the longitudinal direction of the lenses forming the lenticular lens has low absorbance.

On the other hand, as shown in FIG. 6, in a case where a lenticular lens 20 is used as the lens array, it is preferable that the polarizer 24 that disposes the transmission axis 24a in the direction perpendicular to the longitudinal direction of the lenses forming the lenticular lens 20 is provided between the image display element 12 and the anisotropic absorption layer 14.

As a result, in the light obliquely incident into the anisotropic absorption layer 14, the linearly polarized light in the longitudinal direction of the lenses forming the lenticular lens 20 that has low absorbance for the anisotropic absorption layer 14 is shielded, that is, removed in advance by the polarizer 24, and only the oblique incident light in the linearly polarized light in the perpendicular direction can be incident into the anisotropic absorption layer 14.

As a result, in the stereoscopic image display device shown in FIG. 6, light that enters into the range of adjacent pixels as stray light can be further reduced, a decrease in display contrast caused by the stray light can be more suitably suppressed, and a stereoscopic image having high display contrast can be displayed.

Hereinafter, in a case where the polarizer 24 is provided between the anisotropic absorption layer 14 and the image display element 12, a simulation result will be described.

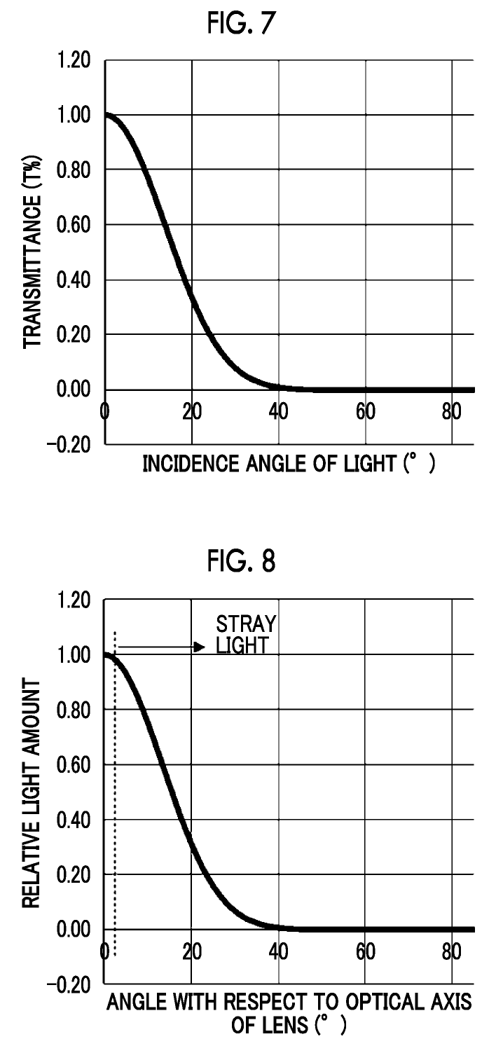

As illustrated in FIG. 6, in a case where the transmission axis 24a is matched to the direction perpendicular to the longitudinal direction of the lenses and the polarizer 24 is provided between the anisotropic absorption layer 14 and the image display element 12, the transmittance of the laminate including the polarizer and the anisotropic absorption layer with respect to an incidence angle of light is as shown in FIG. 7. This laminate changes a light amount distribution of light emitted from the above-described light emitting element having the light amount distribution shown in FIG. 3 to a light amount distribution shown in FIG. 8.

As a result, the light amount of stray light can be reduced to about 20% as compared to a case where light is directly incident from the light emitting element into the lenticular lens 20.

As a result, in the stereoscopic image display device where the lenticular lens 20 is used as the lens array and the anisotropic absorption layer 14 is used as the directivity control layer, by disposing the polarizer 24 such that the longitudinal direction of the lenses forming the lenticular lens 20 and the direction of the transmission axis 24a are perpendicular to each other, a more favorable effect of improving the display contrast can be obtained.

For example, even in a case where the light emitting element is a surface-emitting type as in an OLED display element, by using a display element having a high definition of higher than 100 ppi, the light emitting element in the surface-emitting type such as an OLED is also sufficiently small, and can be treated as a point light source in a pseudo manner.

Therefore, the same effect as the described above can be obtained.

As the polarizer 24, various known linear polarizers (linearly polarizing plates) can be used.

Accordingly, the polarizer 24 may be a reflective or absorptive type. Examples of the polarizer 24 include an iodine-based polarizer, a dye-based polarizer using a dichroic dye, a polyene polarizer, a wire grid polarizer, and a film obtained by stretching a dielectric multi-layer film described in JP2011-053705A.

That is, in the stereoscopic image display device according to the embodiment of the present invention, as the directivity control layer, in addition to the anisotropic absorption layer 14 including the dichroic substance shown in FIGS. 1 and 6, a diffraction element, a metasurface structure, and a laminate including a polarizer, a retardation layer, and a polarizer can also be used.

In addition, optionally, a plurality of these directivity control layers may be used in combination.

Specifically, as the diffraction element that functions as the directivity control layer, a diffraction element that diffracts a light component having a large angle with respect to the optical axis using a diffraction phenomenon to be parallel to the optical axis direction, that is, the normal direction can be used.

Examples of the diffraction element include a diffraction element formed of a surface relief hologram, a volume hologram, a liquid crystal diffraction element, or the like.

In addition, as the directivity control layer, a transmissive metasurface structure that changes a traveling direction of light incident with an angle with respect to the normal direction to be parallel to the normal direction can also be used.

As the metasurface structure, various known metasurface structures where many fine structures corresponding to a wavelength of a stereoscopic image to be displayed are arranged can be used.

The metasurface structure may be designed using a known method depending on transmission characteristics of desired light (electromagnetic waves). For example, the amplitude and the phase of light transmitted through the fine structure to be used may be calculated using commercially available simulation software, and the arrangement of the fine structures may be set to obtain a desired distribution of phase modulation amount (refractive index).

Further, as the directivity control layer, a laminate that includes a polarizer, a retardation layer, and a polarizer in this order and is disposed such that transmission axes of the polarizers are parallel or perpendicular to each other can be used.

More specifically, for example, a laminate having negative biaxiality (nx > ny > nz) that includes a polarizer, a λ/2 wave plate, and a polarizer in this order and where transmission axes of the polarizers are perpendicular to each other and the λ/2 plate is disposed at 45° with the transmission axis of each of the polarizers can be used. In this laminate, for example, in light incident from the normal direction, only P polarized light transmits through the first polarizer, this P polarized light is converted into S polarized light by the λ/2 plate, and the S polarized light transmits through the second polarizer. On the other hand, in light incident from the oblique direction, as the polar angle increases, a retardation change increases depending on a thickness-direction retardation Rth of the λ/2 plate. Therefore, the light is converted into elliptically polarized light, and the transmittance of the second polarizer decreases. As a result, the transmitted light is mainly light in the normal direction, and the directivity of the light can be controlled. In other words, the polar angle refers to an angle with respect to the normal line.

As the thickness-direction retardation Rth of λ/2 increases, large angle selectivity can be exhibited. The λ/2 plate may have hybrid alignment.

In the laminate, as the polarizer and the retardation layer, various known polarizers and retardation layers can be used. In addition, the polarizer may be an absorptive or reflective type.

In addition, in the laminate, the polarizer and the retardation layer, and the polarizer may be disposed in this order, may be laminated with another layer interposed therebetween, and may be bonded to each other to form a laminated structure.

However, as the directivity control layer, the anisotropic absorption layer 14 including the dichroic coloring agent shown in FIGS. 1 and 6 is suitably used from the viewpoints that, for example, light with an angle with respect to the normal direction in the light emitted from the image display element 12 (light emitting element) can be suitably absorbed and removed, the light utilization efficiency can be further improved because the light transmittance of the normal direction is relatively high, and interface reflection is small because the number of layers required is small.

That is, in the stereoscopic image display device according to the embodiment of the present invention, an optical sheet according to the embodiment of the present invention is suitably used, the optical sheet including: a lens array; and an anisotropic absorption layer including a dichroic coloring agent, one surface of the lens array has a planar shape and another surface of the lens array has a curved shape, the anisotropic absorption layer is disposed on the planar surface side of the lens array, and a transmittance central axis of the anisotropic absorption layer is parallel to a normal direction of the planar surface of the lens array.

Hereinabove, the stereoscopic image display device and the optical sheet according to the embodiment of the present invention have been described in detail. However, the present invention is not limited to the above-described examples, and various improvements and modifications can be made within a range not departing from the scope of the present invention.

The present invention is suitably applicable to, for example, a head-mounted display such as virtual reality (VR) goggles.

### EXPLANATION OF REFERENCES

10: stereoscopic image display device

12: image display element

14: anisotropic absorption layer

16: microlens array

20: lenticular lens

24: polarizer

What is claimed is:

1. A stereoscopic image display device comprising, in the following order:
a lens array where a plurality of lenses are disposed in a planar shape;
a directivity control layer; and
a light-emitting image display element,
wherein one surface of the lens array has a planar shape, and another surface of the lens array has a curved shape,
the directivity control layer is disposed on the planar surface side of the lens array,
the directivity control layer is selected from the group consisting of an anisotropic absorption layer including a dichroic substance, a diffraction element, a metasurface structure, and a laminate including a polarizer, a retardation layer, and a polarizer, and
in a case where the directivity control layer is irradiated with light from one surface side, the directivity control layer has a highest luminance in a normal direction of another surface of the directivity control layer.

2. The stereoscopic image display device according to claim 1,
wherein the directivity control layer is the anisotropic absorption layer including the dichroic substance, and a transmittance central axis is parallel to a normal direction of the planar surface of the lens array.

3. The stereoscopic image display device according to claim 2,
wherein the anisotropic absorption layer includes a vertically aligned liquid crystal compound.

4. The stereoscopic image display device according to claim 1,
wherein the lens array is a lenticular lens.

5. The stereoscopic image display device according to claim 4, further comprising:
a polarizer that is provided between the image display element and the directivity control layer,
wherein a transmission axis of the polarizer is a direction perpendicular to a longitudinal direction of a lens forming the lenticular lens.

6. The stereoscopic image display device according to claim 1,
wherein the lens array is a microlens array.

7. An optical sheet comprising:
a lens array where a plurality of lenses are disposed in a planar shape; and
an anisotropic absorption layer including a dichroic substance,
wherein one surface of the lens array has a planar shape, and another surface of the lens array has a curved shape,
the anisotropic absorption layer is disposed on the planar surface side of the lens array, and
a transmittance central axis of the anisotropic absorption layer is parallel to a normal direction of the planar surface of the lens array.

8. The optical sheet according to claim 7,
wherein the anisotropic absorption layer includes a vertically aligned liquid crystal compound.

9. The optical sheet according to claim 7,
wherein the lens array is a lenticular lens.

10. The optical sheet according to claim 9, further comprising:
a polarizer that is provided opposite to the lens array side of the anisotropic absorption layer,
wherein a transmission axis of the polarizer is a direction perpendicular to a longitudinal direction of a lens forming the lenticular lens.

11. The optical sheet according to claim 7,
wherein the lens array is a microlens array.

12. The stereoscopic image display device according to claim 2,
wherein the lens array is a lenticular lens.

13. The stereoscopic image display device according to claim 12, further comprising:
a polarizer that is provided between the image display element and the directivity control layer,
wherein a transmission axis of the polarizer is a direction perpendicular to a longitudinal direction of a lens forming the lenticular lens.

14. The stereoscopic image display device according to claim 2,
wherein the lens array is a microlens array.

15. The optical sheet according to claim 8,
wherein the lens array is a lenticular lens.

16. The optical sheet according to claim 15, further comprising:
a polarizer that is provided opposite to the lens array side of the anisotropic absorption layer,
wherein a transmission axis of the polarizer is a direction perpendicular to a longitudinal direction of a lens forming the lenticular lens.

17. The optical sheet according to claim 8,
wherein the lens array is a microlens array.

18. The stereoscopic image display device according to claim 3,
wherein the lens array is a lenticular lens.

19. The stereoscopic image display device according to claim 18, further comprising:
a polarizer that is provided between the image display element and the directivity control layer,
wherein a transmission axis of the polarizer is a direction perpendicular to a longitudinal direction of a lens forming the lenticular lens.

20. The stereoscopic image display device according to claim 3,
wherein the lens array is a microlens array.
